(19) United States
(12) Patent Application Publication
(10) Pub. No.: US 2023/0045543 A1
(43) Pub. Date: Feb. 9, 2023

(54) COATED ACTIVE MATERIAL AND METHOD FOR PRODUCING THE SAME

(71) Applicants: DOWA ELECTRONICS MATERIALS CO., LTD., Tokyo (JP); TOYOTA JIDOSHA KABUSHIKI KAISHA, Aichi-ken (JP)

(72) Inventors: Kazuki MURAISHI, Tokyo (JP); Masaru KUBOTA, Tokyo (JP); Yuki ISHIGAKI, Tokyo (JP); Masahiro YOSHIDA, Tokyo (JP); Hidefumi FUJITA, Tokyo (JP); Koji TANOUE, Tokyo (JP)

(73) Assignees: DOWA ELECTRONICS MATERIALS CO., LTD., Tokyo (JP); TOYOTA JIDOSHA KABUSHIKI KAISHA, Aichi-ken (JP)

(21) Appl. No.: 17/872,293

(22) Filed: Jul. 25, 2022

(30) Foreign Application Priority Data
Aug. 2, 2021 (JP) 2021-126977

(51) Int. Cl. C01G 33/00; H01M 10/0525; C01B 25/30

(52) U.S. Cl. CPC C01G 33/00; H01M 10/0525; C01B 25/30

(57) ABSTRACT

Provided are a coated active material having excellent properties that can reduce the reaction resistance of a battery, and a method for producing a coated active material that can achieve both a high processing speed and high processing quality. The method for producing a coated active material includes: mixing an electrode active material and a coating solution containing Li and an element M and having a surface energy of 72 mN/m or less to prepare a slurry; and drying the slurry in an air flow and thereby causing a Li-containing oxide to adhere to at least a portion of the surface of the electrode active material, to obtain a coated active material, where the element M is at least one element selected from Nb, F, Fe, P, Ta, V, Ge, B, Al, Ti, Si, W, Zr, Mo, S, Cl, Br, and I.

### BACKGROUND OF THE INVENTION

### 1. Field of the Invention

The present invention relates to a coated active material in which a lithium-containing oxide adheres to at least a portion of the surface of an electrode active material for use in a secondary battery including an all-solid-state lithium ion secondary battery, and a method for producing the coated active material.

### 2. Description of Related Art

All-solid-state batteries have the advantage of facilitating the simplification of a system for ensuring safety and other advantages. As a technology relating to such an all-solid-state battery, the applicant of the present invention has disclosed Japanese Patent No. 6034265. Japanese Patent No. 6034265 discloses a method for producing an active material composite powder that has lithium niobate adhering to the surface thereof and has a predetermined BET specific surface area, the method including a spraying and king step of spraying a coating solution containing Li (lithium) and a peroxo complex of Nb (niobium) onto the surface of an active material and simultaneously king the coating solution, and a heat treatment step of performing a heat treatment after the spraying and king step, as well as a method for producing a lithium battery using the active material composite powder.

In addition to the all-solid-state battery according to Japanese Patent No. 6034265, attempts have been made to improve the characteristics of a lithium ion battery by coating the surface of an electrode active material with a Li compound.

For example, the applicant of the present invention has disclosed, in JP 2018-60749A, a technology relating to an active material composite powder in which at least a portion of the surface of a positive electrode active material is coated with Al₂O₃ or Li₃PO₄ using a vapor deposition (ALD: atomic layer deposition) apparatus in order to provide a lithium ion secondary battery having a high capacity retention rate, that is, including a non-aqueous electrolytic solution with excellent durability.

Japanese Patent No. 6034265 and JP 2018-60749A are examples of related art.

However, further studies conducted by the inventors of the present invention showed that there are problems in terms of productivity with the methods for producing an active material composite powder disclosed in Japanese Patent No. 6034265 and JP 2018-60749A.

More specifically, according to the method for producing an active material composite powder disclosed in Japanese Patent No. 6034265, a tumbling fluidized bed coating method is used in the spraying and drying step. However, since the disintegrating force applied to the powder in the tumbling fluidized bed coating method is weak, it is difficult to disintegrate large granules composed of the active material and the coating solution once they are formed. The formation of large granules may lead to a reduction in battery performance, such as an increase in the reaction resistance. To address this issue, the rate at which the coating solution is sprayed onto the active material is reduced to perform drying before large granules are formed, and for this reason, the processing speed has to be reduced. That is to say, there is an essential problem in that it is difficult to achieve both a high processing speed and high processing quality (suppression of granule formation), and thus, the productivity of the step is low.

In the present invention, the term “disintegrate” refers to an operation of applying mechanical energy to agglomerated particles to loosen the bonds between the agglomerated particles mostly without forming new solid surfaces, and thereby reducing the size of the particles, and is used as a different concept from the term “grind”, which is an operation of applying energy to solid particles to reduce the size of the particles and form new surfaces.

On the other hand, the method disclosed in JP 2018-60749A, in which a vapor deposition (ALD: atomic layer deposition) apparatus is used, is not practical in terms of processing speed, because the ALD apparatus performs a vacuum process.

### SUMMARY OF THE INVENTION

The present invention was made under the above-described circumstances, and it is an object thereof to provide a coated active material having excellent properties that can reduce the reaction resistance of a battery, and a method for producing a coated active material that can achieve both a high processing speed and high processing quality.

The inventors of the present invention conducted studies to achieve the above-described object and have consequently devised a coating solution with low surface energy. Specifically, the inventors of the present invention have devised a coating solution with a surface energy of 72 mN/m or less. In contrast, for example, the coating solution disclosed in Japanese Patent No. 6034265 had a surface energy of more than 72 mN/m.

Furthermore, the inventors of the present invention have devised a configuration in which a coated active material is produced by mixing the coating solution with low surface energy and an electrode active material in advance to form a slurry, and disintegrating the slurry while drying the slurry in an air flow.

That is to say, a first aspect of the invention for achieving the above-described object is a method for producing a coated active material, the method including:

mixing an electrode active material and a coating solution containing Li and an element M and having a surface energy of 72 mN/m or less to prepare a slurry; and

drying the slurry in an air flow and thereby causing a Li-containing oxide to adhere to at least a portion of a surface of the electrode active material, to obtain a coated active material,

where the element M is at least one element selected from Nb, F, Fe, P, Ta, V, Ge, B, Al, Ti, Si, W, Zr, Mo, S, Cl, Br, and I.

A second aspect of the invention is the method for producing a coated active material according to the first aspect of the invention, wherein the coating solution contains Li in an amount of 0.1 mass % or more and 5.0 mass % or less, the element M in an amount of 0.05 mass % or more and 35 mass % or less, and water in an amount of 60 mass % or more and 98.4 mass % or less.

A third aspect of the invention is the method for producing a coated active material according to the first aspect of the invention, wherein the element M is at least one element selected from Nb and P.

A fourth aspect of the invention is the method for producing a coated active material according to the second aspect of the invention, wherein the element M is at least one element selected from Nb and P.

A fifth aspect of the invention is a coated active material, which is a dry product of a mixture of an electrode active material and a coating solution containing Li and an element M and having a surface energy of 72 mN/m or less,

where the element M is at least one element selected from Nb, F, Fe, P, Ta, V, Ge, B, Al, Ti, Si, W, Zr, Mo, S, Cl, Br, and I.

A sixth aspect of the invention is an all-solid-state battery including the coated active material according to the fifth aspect of the invention as a positive electrode active material.

According to the present invention, both a high processing speed and high processing quality can be achieved in the production of a coated active material, and a coated active material having excellent properties that can reduce the reaction resistance of a battery can be produced with high productivity.

### BRIEF DESCRIPTION OF THE DRAWINGS

FIG. 1 is a graph showing the relationship between the value of surface energy and coverage with respect to coating solutions for coating a positive electrode active material.

FIG. 2 is a graph showing the relationship between the value of polar component of surface energy and coverage with respect to the coating solutions for coating a positive electrode active material.

### DETAILED DESCRIPTION OF THE INVENTION

The present invention relates to a coated active material for use in an all-solid-state battery or a lithium ion secondary battery including a non-aqueous electrolytic solution, wherein a lithium-containing oxide adheres to at least a portion of the surface of an electrode active material, as well as a method for producing the coated active material. Specifically, an electrode active material and a coating solution containing Li and an element M, which will be described later, and having low surface energy are mixed to prepare a slurry. Then, the slurry is dried in an air flow. The present invention relates to the thus obtained coated active material in which a Li-containing oxide adheres to at least a portion of the surface of the electrode active material, and a method for producing the coated active material.

According to the present invention, in the production of a coating solution and a coated active material, (1) a coating solution whose surface energy is adjusted to be low is used, and (2) an electrode active material and the coating solution are mixed in advance to prepare a slurry, and then the slurry is dried in an air flow to obtain a coated active material. The present invention has these features and effects resulting from these features.

(1) A coating solution whose surface energy is adjusted to be low is used.

The use of a coating solution with a surface energy of 72 mN/m or less theoretically reduces the size of slurry droplets in an air flow, which will be described later, and accordingly, the size of granules formed by drying the slurry is small. The thus formed small granules collide with each other in the air flow and are quickly disintegrated, so that granulation of the resulting coated active material can be suppressed. Therefore, both a high processing speed and high processing quality can be achieved without the necessity for an additional disintegrating step and the like.

(2) An electrode active material and the coating solution are mixed in advance to prepare a slurry, and then the slurry is dried in an air flow to obtain a coated active material.

Although there is no particular limitation on the method for drying the slurry in an air flow, a spray dryer, for example, can be suitably used. In this case, there is no limitation on the spraying method, and the slurry can be formed into droplets using a rotary atomizer or a nozzle. Furthermore, it is also preferable to convey the resulting powder to a cyclone apparatus provided downstream of the spray dryer and disintegrate the powder while further drying the powder in an air flow.

In short, instead of spraying a coating solution onto an electrode active material in small amounts as with the tumbling fluidized bed coating method according to the conventional technology, the electrode active material and the coating solution are mixed in advance to prepare a slurry, and, while the slurry is dried in an air flow and converted into a powder using, for example, a spray dryer and a cyclone apparatus, the powder is disintegrated. Thus, the processing speed is increased. Note that the above-described combination of a spray dryer and a cyclone apparatus is a preferred configuration because disintegration proceeds to some extent in the cyclone apparatus as well. However, this configuration is not essential in the present invention because, even without the cyclone apparatus, disintegration proceeds in the air flow in the spray dryer.

In contrast, in the tumbling fluidized bed coating method according to the conventional technology, the coating solution is sprayed onto the electrode active material little by little over a long period of time. This limits the spraying rate of the coating solution, and therefore, there is a problem in that the processing speed cannot be increased. According to the present invention, the production speed of the coated active material is significantly increased by preparing the slurry in which the coating solution and the electrode active material are mixed from the beginning.

Hereinafter, the present invention will be described in the following order: 1. Coating Solution, 2. Slurry Containing Electrode Active Material and Coating Solution, 3. Coating of Electrode Active Material with Coating Solution, 4. Firing of Coated Active Material Precursor, and 5. Evaluation of Coated Active Material.

### 1. Coating Solution

The coating solution according to the present invention will be described in the following order: (1) Composition of Coating Solution, (2) Lithium Compound, (3) Element M Compound, (4) Method for Adjusting Surface Energy, (5) Evaluation of Polar and Dispersive Components of Surface Energy of Coating Solution, (6) Method for Determining of Water Content, and (7) Features of Coating Solution According to the Present Invention

### (1) Composition of Coating Solution

The coating solution according to the present invention contains: Li in an amount of 0.1 mass % or more and 5.0 mass % or less; at least one element (also referred to as “element M” in the present invention) selected from Nb, F (fluorine), Fe (iron), P (phosphorus), Ta (tantalum), V (vanadium), Ge (germanium), B (boron), Al (aluminum), Ti (titanium), Si (silicon), W (tungsten), Zr (zirconium), Mo (molybdenum), S (sulfur), Cl (chlorine), Br (bromine), and I (iodine) in an amount of 0.05 mass % or more and 35 mass % or less; and water in an amount of 60 mass % or more and 98.4 mass % or less.

In the coating solution according to the present invention, when the concentration of Li is 0.1 mass % or more, a coating solution for a lithium-containing oxide coating layer can be obtained. On the other hand, when the concentration of Li is 5.0 mass % or less, the solubility in a solvent contained in the coating solution can be ensured.

The coating solution according to the present invention contains an element M together with Li, and thus, a coating solution for obtaining an oxide coating layer having lithium conductivity can be obtained. In particular, from the viewpoint of improving the voltage resistance of the coating layer, Nb and P are preferred examples of the element M. When the coating layer has high voltage resistance, the battery can operate at higher voltages, and, for example, the charging time can be reduced.

If the concentration of the element M in the coating solution is less than 0.05 mass %, the Li concentration in the coating solution is excessive, and accordingly, lithium hydroxide with low lithium ion conductivity is highly likely to be generated and mixed in the coating layer during the formation of the coating layer. Therefore, from the viewpoint of ensuring the lithium ion conductivity of a coating layer to be formed, the concentration of the element M in the coating solution is preferably 0.05 mass % or more. On the other hand, when the concentration of the element M is 35 mass % or less, the solubility in the solvent contained in the coating solution can be ensured. As the element M, a plurality of elements may be contained. In that case, the total concentration of the plurality of elements M is preferably 0.05 mass % or more and 35 mass % or less.

A solvent composed mainly of water is used as the solvent of the coating solution according to the present invention.

When the water content in the coating solution is 60 mass % or more, the coating solution is stable in the air. As a result, the operation of coating the electrode active material with the coating solution can be easily performed in the air. On the other hand, when the water content is 98.4 mass % or less, it is possible to avoid an increase in the amount of the coating solution used to obtain a coating layer having a predetermined film thickness, the increase being caused by the low concentrations of Li and the element M in the coating solution

### (2) Lithium Compound

There is no particular limitation on a lithium compound contained in the coating solution according to the present invention, and any lithium compound can be used as long as it dissolves in the solvent used.

However, when a solvent composed mainly of water is used, preferred examples of the lithium compound include lithium salts such as lithium hydroxide (LiOH), lithium nitrate (LiNO₃), lithium sulfate (Li₂SO₄), lithium carbonate (Li₂CO₃), and lithium nitrite (LiNO₂) because they do not bring impurities into the solution.

### (3) Element M Compound

There is no limitation on an element M compound contained in the coating solution according to the present invention, and any element M compound can be used as long as it dissolves in the solvent used.

However, when a solvent composed mainly of water is used, if the element M can form a complex compound of the element M (also referred to as “element M complex” in the present invention), it is preferable to use the element M complex. This is because an element M complex is preferable in that it stably dissolves in a solvent composed mainly of water.

In particular, a peroxo complex of the element M can be suitably used as a water-soluble element M complex. A peroxo complex of the element M is particularly preferable because it does not contain carbon in its chemical structure and carbon does not remain in a coating film that is finally formed on the electrode active material.

In a solution containing, for example, Li and Nb as the element M, a peroxo complex of Nb can be identified by performing a measurement using a single reflection ATR method in which an FT-IR apparatus is used, with the angle of incidence on a germanium prism being set to 45°.

If peaks at 855 cm⁻¹±20 cm⁻¹ and 1650 cm⁻¹±10 cm⁻¹, which are attributed to a peroxo complex, are observed as a result of the measurement, Nb dissolved in the solution containing Li and Nb can be considered to be in the form of a niobium complex (or more specifically, peroxo complex).

Note that, when P is used as the element M, it is preferable to use lithium phosphate, which is a water-soluble compound of P and Li.

### (4) Method for Adjusting Surface Energy

The value of the surface energy of the solvent constituting the coating solution according to the present invention, and the value of the polar component, can be controlled by adding an appropriate amount of surfactant to the solvent.

Here, the term “surfactant” refers to a substance that has a hydrophilic portion and a hydrophobic (lipophilic) portion in the molecule and that is adsorbed on a water-oil two-phase interface due to its hydrophilic-lipophilic balance, thereby having the effect of lowering the surface free energy (surface tension).

As the surfactant, an alcohol and a nonionic surfactant having a nonionic polar group are preferable.

As the alcohol, those, such as 1,2-propanediol and 1-butanol, containing three or more carbon atoms in the molecule, being soluble in water, and being capable of ensuring the stability of the element M compound are particularly preferable. As the nonionic surfactant, those in which the nonionic polar group is constituted by an ether bond are particularly preferable, such as polyoxyethylene ethers (e.g., Ftergent (registered trademark) 222F with 22 moles of ethylene oxide added (manufactured by Neos Company Limited)), polyoxyethylene alkyl ethers (e.g., LEOCOL (registered trademark) TD-120 with 12 moles of ethylene oxide added (manufactured by Lion Corporation)), diethylene glycol diethyl ethers (e.g., DEDG (registered trademark) (Nippon Nyukazai Co., Ltd.)), and polyoxyethylene lauryl ethers (e.g., EMULGEN (registered trademark) 108 (manufactured by Kano Corporation)).

The amount of one or more surfactants, the one or more surfactants being selected from alcohols and nonionic surfactants, that are added to the solvent constituting the coating solution according to the present invention in order to control the value of the surface energy of the solvent and the value of the polar component can be 0.01 mass % or more and 20.0 mass % or less, from the viewpoint of reducing the surface energy and controlling the value of the polar component to improve the wettability on the electrode active material. When the surfactant is an alcohol, the amount of the surfactant added is preferably 0.1 mass % or more and 20.0 mass % or less, and more preferably 1.0 mass % or more and 10.0 mass % or less. On the other hand, when the surfactant is a nonionic surfactant, the amount of the surfactant added is preferably 0.01 mass % or more and 10.0 mass % or less, and more preferably 0.01 mass % or more and 5.0 mass % or less.

The one or more surfactants selected from alcohols and nonionic surfactants are added to the solvent within the above-described range of the amount added, while measuring the value of the surface energy of the solvent and the value of the polar component. The value of the surface energy is adjusted to 72 mN/m or less. At this time, the value of the polar component is preferably adjusted to 0 mN/m or more and 45 mN/m or less. The value of the surface energy is more preferably adjusted to 15 mN/m or more and 40 mN/m or less, and at this time, the value of the polar component is more preferably adjusted to 0 mN/m or more and 15 mN/m or less.

The value of the surface energy of the coating solution according to the present invention is adjusted to 72 mN/m or less, which means that the surface energy is adjusted to be low, and thus, when the coating solution is applied to the powder surface of the electrode active material and dried to form a coating layer, the coating solution sufficiently coats the powder surface and also has a low liquid bridge force. As a result, even when a mixture of the coating solution and the electrode active material forms granules, the granules are quick to disintegrate during pneumatic conveying drying.

Furthermore, the reduction of the value of the surface energy of the coating solution improves the wettability on the electrode active material, so that the coating solution uniformly wets and spreads on the surface of the electrode active material when applied thereto, forming a uniform coating layer with reduced thin film portions, and thus, the coverage is improved. A sufficient coverage can be achieved by adjusting the value of the surface energy to 72 mN/m or less.

On the other hand, if the value of the surface energy of the coating solution is excessively small relative to the value of the surface energy of the electrode active material, the coating solution is likely to peel off the surface of the electrode active material. As a result, the likelihood of a non-uniform coating layer being formed and the coverage being reduced increases. Therefore, the surface energy is preferably 15 mN/m or more.

### (5) Evaluation of Polar and Dispersive Components of Surface Energy of Coating Solution

The value of the surface energy of the coating solution according to the present invention was measured at 25° C. using an automatic surface tensiometer CBVP-Z manufactured by Kyowa Interface Science Co., Ltd.

The polar and dispersive components of the surface energy of the coating solution according to the present invention were evaluated in the following manner.

A glass slide was dipped in paraffin (FUJIFILM Wako Pure Chemical Corporation, 1st grade reagent) melted at 90° C. on a hot plate. After the glass slide was removed therefrom, the glass slide was slowly cooled in the air at 25° C. to prepare a paraffin substrate. The surface roughness Ra was measured using a shape measurement laser microscope (Keyence Corporation, VK-9710).

With the paraffin substrate temperature set to 25° C. and the solution temperature set to 25° C., about 10 μL of the coating solution was added dropwise onto the substrate in the air, and the contact angle after 3 seconds was obtained using the θ/2 method.

Based on the obtained contact angle, the value of the surface energy of the coating solution, and literature values regarding the surface energy of paraffin (surface energy: γ=25.5 mJ/m², dispersive component of surface energy: γ^{d}=25.5 mJ/m², and polar component of surface energy: γ^{p}=0.00 mJ/m²), the values of the polar and dispersive components constituting the value of the surface energy of the coating solution were calculated using the Young-Dupre equation.

### (6) Method for Determining Water Content

The water content was measured by volumetric titration using a Karl Fischer moisture meter.

Specifically, a volumetric titration type Karl Fischer moisture meter (MKA-610 manufactured by Kyoto Electronics Manufacturing Co., Ltd.) was used, Composite 5K manufactured by Honeywell was used as a titrant, and Medium K manufactured by Honeywell was used as a solvent.

After the solvent contained in a titration flask was made anhydrous with the titrant, a sample was directly added thereto, and the water content was measured.

### (7) Features of Coating Solution According to the Present Invention

With the coating solution according to the present invention described above, a coated active material having a coating layer can be produced by applying the coating solution to an electrode active material and drying the coating solution. Also, the coating solution according to the present invention is free of hydrolyzable components and thus has the advantage of being able to be handled in air and requiring no dry-atmosphere equipment such as a dry room. Furthermore, the coating solution according to the present invention has excellent wettability on the electrode active material, and can therefore coat the entire surface of the electrode active material without leaving any gaps in a single application and also improves the coverage, and thus, the output on the surface of the coated active material can be increased.

### 2. Slurry Containing Electrode Active Material and Coating Solution

Any common electrode active materials for use in secondary batteries and the like can be used as the electrode active material without limitation. The electrode active material is not limited to a positive electrode active material, and a negative electrode active material may also be used. Specific examples of the electrode active material include LiCoO₂, LiNiO₂, and LiMnO₄, as well as LiCoO₂, LiNiO₂, and LiMnO₄ doped with a different element; lithium metal phosphates such as lithium titanate and LiFePO₄; and graphite, carbon, and the like. It is also possible to use a mixture of two or more selected from these electrode active materials. However, preferred electrode active materials are Li—Ni—Mn—Co—O-based complex oxides, which are positive electrode active materials.

The coating solution according to the present invention and the electrode active material are mixed to prepare a slurry as a mixture.

Here, since the coating solution according to the present invention is stable in the air as described above, the mixing operation can be performed in the air. Naturally, it is also preferable to perform the mixing operation in an inert gas atmosphere such as a nitrogen gas atmosphere.

As a stirring device, various types of mechanical and magnetic stirrers can be used as long as a uniform slurry can be produced. However, even if granules composed of the coating solution and the electrode active material are formed in the slurry during the stirring step, this can be dealt with in a downstream step in the present invention.

### 3. Coating of Electrode Active Material

In this step, the slurry of the coating solution and the electrode active material is dried in an air flow to produce a coated active material or a coated active material precursor.

Here, depending on the composition of the coating solution, a coated active material or a coated active material precursor may be generated when the slurry of the coating solution and the electrode active material is dried in an air flow. In the case where a coated active material precursor is generated, a coated active material can be obtained by performing a predetermined heat treatment, which will be described later, on the coated active material precursor.

For example, in the case where P is used as the element M in the coating solution, a coated active material is generated when the slurry of the coating solution and the electrode active material is dried in an air flow.

Alternatively, for example, in the case where Nb is used as the element M in the coating solution, a coated active material precursor is generated when the slurry of the coating solution and the electrode active material is dried in an air flow.

That is to say, whether a coated active material is generated or a coated active material precursor is generated when the slurry of the coating solution and the electrode active material is dried in an air flow depends on the operating conditions (air supply temperature) during pneumatic conveying king and the reactivity of Li and the element M. In addition, if a desired coating layer is not formed at the time of king, a predetermined heat treatment may be additionally performed.

In the step of drying the slurry of the coating solution and the electrode active material in an air flow to produce a coated active material or a coated active material precursor, the pneumatic conveying king conditions are as follows:

the slurry feed rate is 0.1 to 1.0 g/sec;

the inlet temperature of a king gas used for pneumatic conveying drying is 100° C. to 350° C.;

the airflow rate of the drying gas is 0.3 m³/min to 2.5 m³/min; and

the gas/liquid ratio (value obtained by dividing the drying gas volume per unit time by the slurry volume) when the slurry is formed into droplets and dried can be set to 1000 or more.

As a specific example, if a spray dryer is used to dry the slurry of the coating solution and the electrode active material in an air flow, the slurry of the coating solution and the electrode active material can be supplied to the spray dryer at a feed rate of 0.1 to 1.0 g/sec, and the inlet temperature of the drying gas used for pneumatic conveying drying can be set to 100° C. to 350° C. These conditions may be changed according to the desired coating state and the materials. Similarly, the airflow rate of the drying gas can be set to any suitable value within the range of 0.3 m³/min to 2.5 m³/min. If the slurry is formed into droplets and dried using a spray nozzle, the gas/liquid ratio can be set to 1000 or more. With this ratio, stable droplets can be formed, and the processing can be stabilized.

In particular, it is also preferable to use a spray dryer in which a cyclone is connected downstream of a drying chamber equipped with a spray nozzle. As a result of performing pneumatic conveying drying in the cyclone, even if granules composed of the coating solution and the electrode active material are formed in the slurry, the disintegrating force according to the high flow rate in the cyclone, combined with the fact that the value of the surface energy of the coating solution is 72 mN/m or less, enables the production of a coated active material or a coated active material precursor in which the granules are disintegrated, while ensuring a high processing speed.

In contrast, in the case where coating of the electrode active material is performed using the tumbling fluidized bed coating method according to the conventional technology, when, for example, the temperature of the air supply gas is 120° C., and the inlet airflow rate is 0.4 m³/h, if the feed rate of the coating solution is increased to about 0.2 g/sec or more, granules composed of the coating solution and the electrode active material are formed irrespective of the surface energy, and the granules may remain in the resulting coated active material and ultimately reduce the battery performance.

Here, it is conceivable to perform additional disintegration in an air flow at the stage where the formation of granules composed of the coating solution and the electrode active material is confirmed. However, if additional disintegration is performed, the coverage of the coated active material may decrease as an adverse effect (see Comparative Examples 1 to 4, which will be described later). Moreover, additional disintegration may cause not only a decrease in the processing quality but also a decrease in the processing speed due to the addition of a new step. In view of these issues as well, it is important to adjust the value of the surface energy of the coating solution to 72 mN/m or less.

From the foregoing, when compared with the conventional technologies with which it is difficult to achieve both a high processing speed and high processing quality (suppression of granule formation), the present invention, which is capable of significantly increasing the processing speed by perfuming pneumatic conveying drying of slurry droplets, can be considered to have a significant inventive step.

### 4. Firing of Coated Active Material Precursor

As already described in “3. Coating of Electrode Active Material”, if a coated active material precursor is generated when the slurry of the coating solution and the electrode active material is dried in an air flow, the coated active material precursor is fired at 100° C. to 500° C. for more than 0 minute and 10 hours or less using, for example, a muffle furnace. As a result, a lithium-containing oxide is synthesized on the surface of the electrode active material, and the lithium-containing oxide adheres to at least a portion of the surface of the electrode active material. Thus, a coated active material can be produced.

As described above, depending on the composition of the coating solution, a target lithium-containing oxide may be generated during pneumatic conveying drying. Therefore, this firing step can be perfumed as necessary.

### 5. Evaluation of Coated Active Material

Evaluation of the coated active material according to the present invention will be described in the following order: (1) Processing Quality (Suppression of Granule Formation), and (2) Coverage of Coating.

### (1) Processing Quality (Suppression of Granule Formation)

The amount of granules formed in the coated active material can be evaluated by measuring the particle size D90 at cumulative 90% in a volume-based particle size distribution of the coated active material. If granules are formed during the coating of the electrode active material with the coating solution, the contact area between the electrode active material and a solid electrolyte during the electrode formation decreases, resulting in a reduced output. For this reason, it is important that a small amount of granules are formed.

Specifically, with use of a laser diffraction and scattering measurement apparatus (AEROTRAC II manufactured by MicrotracBEL Corp.), the particle size D90 at cumulative 90% in the volume-based particle size distribution of each of the electrode active material and the coated active material is measured. It is important that the value of “D90 of coated active material/D90 of electrode active material” is 1.0 or more and 1.55 or less, preferably 1.0 or more and 1.5 or less, more preferably 1.0 or more and 1.2 or less, and most preferably close to 1.0.

### (2) Coverage of Coating

In the coated active material, it is important that the surface of the electrode active material is sufficiently coated with the lithium-containing oxide.

The method for measuring the coverage of the coating will be described using, as an example, a coated active material that is produced when, for example, Nb is selected as the element M.

Specifically, surface element analysis is performed using an X-ray photoelectron spectroscopy apparatus (XPS) (X-tool manufactured by ULVAC-PHI, Inc.). Then, the element ratio of the surface is obtained from the various peaks of C₁ₛ, O₁ₛ, Nb_{3d}, Ni₂ₚ₃, Co₂ₚ₃, and Mn₂ₚ₃, and the coverage is calculated using the equation below:

Coverage (%)=(100×Nb)/(Ni+Co+Mn+Nb) (equation)

where the symbols of the elements represent the percentages [atomic %] of the respective elements.

On the other hand, when, for example, P is selected as the element M, the element ratio of the surface is obtained using the peak of P₂ₚ instead of Nb_{3d}.

Also, it is important that a relative value of the coverage of the coated active material analyzed in a similar manner is 0% or more and 15% or less.

### Examples

Hereinafter, the present invention will be described in greater detail with reference to examples. However, the present invention is not limited to the examples below.

### Example 1

### 1. Preparation of Coating Solution

An aqueous solution of hydrogen peroxide was prepared by adding 7.7 g of hydrogen peroxide solution with a concentration of 35 mass % to 19.6 g of pure water. Then, 4.4 g of niobic acid (Nb₂O₅·5.5H₂O(Nb₂O₅ content 58.0%)) was added to this aqueous solution of hydrogen peroxide. After the addition of niobic acid, the temperature was adjusted so that the liquid temperature of the solution to which niobic acid had been added/containing niobic acid was within a range of 20° C. to 30° C.

Then, 3.5 g of aqueous ammonia with a concentration of 28 mass % was added to this solution containing niobic acid, and the resulting mixture was sufficiently stirred in the air to obtain a transparent solution.

In a nitrogen gas atmosphere, 0.9 g of lithium hydroxide monohydrate (LiOH·H₂O) was added to the obtained transparent solution to obtain a transparent aqueous solution containing Li and a peroxo complex of Nb. Then, the aqueous solution containing Li and the peroxoniobium complex was left to stand at a temperature of 25° C. for about 6 hours. When a precipitate was formed during the standing, the aqueous solution containing Li and the peroxoniobium complex was stirred to such an extent that the precipitate was dispersed, and then filtered through a membrane filter with a pore size of 0.5 μm.

Then, 0.3 g of 1,2-propanediol (special grade reagent) was added to 29.7 g of the prepared solution containing Li and the peroxoniobium complex, and the resulting mixture was stirred for 10 minutes or longer while the temperature was adjusted so that the liquid temperature was within a range of 20° C. to 30° C. Thus, a coating solution according to Example 1 was obtained.

The obtained coating solution according to Example 1 was subjected to (1) quantitative analysis of the Li content and the Nb content, (2) quantitative analysis of the water content, and (3) measurement of the surface energy (polar component and dispersive component) values. Tables 1 and 2 show the results.

### 2. Preparation of Slurry

As an electrode active material, a positive electrode active material, LiNi_{1/3}Mn_{1/3}Co_{1/3}O₂, was prepared, and a slurry was prepared by adding 23.3 g of the coating solution according to Example 1 to 40.0 g of the electrode active material, and stirring the resulting mixture using a magnetic stirrer.

### 3. Preparation of Coated Active Material Precursor

The prepared slurry was supplied to a spray dryer (Mini Spray Dyer B-290 manufactured by BUCHI) at a rate of 0.5 g/sec using a liquid feed pump. Note that the spray dryer included a spray nozzle, and a cyclone apparatus was provided downstream.

Slurry droplets were dried in an air flow, and a coated active material precursor was collected.

The spray dryer was operated under the following conditions:

Air supply temperature (Inlet temperature of king gas): 200° C.

Supply airflow rate: 0.45 m³/min

### 4. Preparation of Coated Active Material

The collected coated active material precursor was fired at 200° C. for 5 hours using a muffle furnace to synthesize lithium niobate on the surface of the electrode active material, and thus, a coated active material according to Example 1 was obtained.

### 5. Evaluation of Properties of Coated Active Material

### (1) Measurement of Particle Size

For each of the coated active material according to Example 1 and the prepared electrode active material (LiNi_{1/3}Mn_{1/3}Co_{1/3}O₂), the particle size D90 at cumulative 90% in a volume-based particle size distribution was measured using a laser diffraction and scattering measurement apparatus (AEROTRAC II manufactured by MicrotracBEL Corp.).

Then, the value of “D90 (μm) of coated active material/D90 (μm) of electrode active material” was obtained. Table 2 shows the results.

### (2) Evaluation of Coverage

The coated active material according to Example 1 was subjected to surface element analysis using X-ray photoelectron spectroscopy (X-tool manufactured by ULVAC-PHI, Inc.). Then, the element ratio of the surface was obtained from the various peaks of Nb_{3d}, Ni₂ₚ₃, Co₂ₚ₃, and Mn₂ₚ₃, and the coverage was calculated using the equation below:

Coverage (%)=(100×Nb)/(Ni+Co+Mn+Nb) (equation)

where the symbols of the elements represent the percentages [atomic %] of the respective elements.

Subsequently, the amount of change in the coverage was calculated using the value of the coverage of a coated active material according to Comparative Example 1, which will be described later, as a reference value, and the value of the amount of change in the coverage was obtained as a relative value of the increase/decrease in the coverage. Then, it was found that the coverage of the coated active material was 5% higher than that of Comparative Example 1. Table 2 shows the results.

### Example 2

A coating solution according to Example 2 was obtained by performing the same operation as in Example 1, except that, in “1. Preparation of Coating Solution” of Example 1 above, 3.0 g of 1,2-propanediol (special grade reagent) was added to 27.0 g of the prepared solution containing Li and the peroxoniobium complex.

The obtained coating solution according to Example 2 was subjected to (1) quantitative analysis of the Li content and the Nb content, (2) quantitative analysis of the water content, and (3) measurement of the surface energy (polar component and dispersive component) values. Tables 1 and 2 show the results.

A coated active material according to Example 2 was prepared by performing the same operation as in Example 1, except that, in “2. Preparation of Slurry” of Example 1 above, the coating solution according to Example 2 was used instead of the coating solution according to Example 1.

For the prepared coated active material according Example 2, the same operation as in Example 1 was performed to calculate the value of “D90 (μm) of coated active material/D90 (μm) of electrode active material” and also calculate the amount of change in the coverage using the value of the coverage of the coated active material according to Comparative Example 1, which will be described later, as the reference value, and the value of the amount of change in the coverage was obtained as a relative value of the increase/decrease in the coverage. Table 2 shows the results.

### Example 3

A coating solution according to Example 3 was obtained by performing the same operation as in Example 1, except that, in “1. Preparation of Coating Solution” of Example 1 above, 0.03 g of Ftergent 222F (manufactured by Neos Company Limited) was added, instead of 1,2-propanediol, to 29.97 g of the prepared solution containing Li and the peroxoniobium complex.

The obtained coating solution according to Example 3 was subjected to (1) quantitative analysis of the Li content and the Nb content, (2) quantitative analysis of the water content, and (3) measurement of the surface energy (polar component and dispersive component) values. Tables 1 and 2 show the results.

A coated active material according to Example 3 was prepared by performing the same operation as in Example 1, except that, in “2. Preparation of Slurry” of Example 1 above, the coating solution according to Example 3 was used instead of the coating solution according to Example 1.

For the prepared coated active material according Example 3, the same operation as in Example 1 was performed to calculate the value of “D90 (μm) of coated active material/D90 (μm) of electrode active material” and also calculate the amount of change in the coverage using the value of the coverage of the coated active material according to Comparative Example 1, which will be described later, as the reference value, and the value of the amount of change in the coverage was obtained as a relative value of the increase/decrease in the coverage. Table 2 shows the results.

### Example 4

A coating solution according to Example 4 was obtained by performing the same operation as in Example 1, except that, in “1. Preparation of Coating Solution” of Example 1 above, 0.3 g of Ftergent 222F (manufactured by Neos Company Limited) was added, instead of 1,2-propanediol, to 29.7 g of the prepared solution containing Li and the peroxoniobium complex.

The obtained coating solution according to Example 4 was subjected to (1) quantitative analysis of the Li content and the Nb content, (2) quantitative analysis of the water content, and (3) measurement of the surface energy (polar component and dispersive component) values. Tables 1 and 2 show the results.

A coated active material according to Example 4 was prepared by performing the same operation as in Example 1, except that, in “2. Preparation of Slurry” of Example 1 above, the coating solution according to Example 4 was used instead of the coating solution according to Example 1.

For the prepared coated active material according Example 4, the same operation as in Example 1 was performed to calculate the value of “D90 (μm) of coated active material/D90 (μm) of electrode active material” and also calculate the amount of change in the coverage using the value of the coverage of the coated active material according to Comparative Example 1, which will be described later, as the reference value, and the value of the amount of change in the coverage was obtained as a relative value of the increase/decrease in the coverage. Table 2 shows the results.

### Example 5

A coating solution according to Example 5 was obtained by performing the same operation as in Example 1, except that, in “1. Preparation of Coating Solution” of Example 1 above, 0.3 g of LEOCOL TD-120 (manufactured by Lion Corporation) was added, instead of 1,2-propanediol, to 29.7 g of the prepared solution containing Li and the peroxoniobium complex.

The obtained coating solution according to Example 5 was subjected to (1) quantitative analysis of the Li content and the Nb content, (2) quantitative analysis of the water content, and (3) measurement of the surface energy (polar component and dispersive component) values. Tables 1 and 2 show the results.

A coated active material according to Example 5 was prepared by performing the same operation as in Example 1, except that, in “2. Preparation of Slurry” of Example 1 above, the coating solution according to Example 5 was used instead of the coating solution according to Example 1.

For the prepared coated active material according Example 5, the same operation as in Example 1 was performed to calculate the value of “D90 (μm) of coated active material/D90 (μm) of electrode active material” and also calculate the amount of change in the coverage using the value of the coverage of the coated active material according to Comparative Example 1, which will be described later, as the reference value, and the value of the amount of change in the coverage was obtained as a relative value of the increase/decrease in the coverage. Table 2 shows the results.

### Example 6

A coating solution according to Example 6 was obtained by performing the same operation as in Example 1, except that, in “1. Preparation of Coating Solution” of Example 1 above, 0.3 g of DEDG (manufactured by Nippon Nyukazai Co., Ltd.) was added, instead of 1,2-propanediol, to 29.7 g of the prepared solution containing Li and the peroxoniobium complex.

The obtained coating solution according to Example 6 was subjected to (1) quantitative analysis of the Li content and the Nb content, (2) quantitative analysis of the water content, and (3) measurement of the surface energy (polar component and dispersive component) values. Tables 1 and 2 show the results.

A coated active material according to Example 6 was prepared by performing the same operation as in Example 1, except that, in “2. Preparation of Slurry” of Example 1 above, the coating solution according to Example 6 was used instead of the coating solution according to Example 1.

For the prepared coated active material according Example 6, the same operation as in Example 1 was performed to calculate the value of “D90 (μm) of coated active material/D90 (μm) of electrode active material” and also calculate the amount of change in the coverage using the value of the coverage of the coated active material according to Comparative Example 1, which will be described later, as the reference value, and the value of the amount of change in the coverage was obtained as a relative value of the increase/decrease in the coverage. Table 2 shows the results.

### Comparative Example 1

A coating solution according to Comparative Example 1 was obtained by performing the same operation as in Example 1, except that, in “1. Preparation of Coating Solution” of Example 1 above, 1,2-propanediol was not added to the prepared solution containing Li and the peroxoniobium complex.

The obtained coating solution according to Comparative Example 1 was subjected to (1) quantitative analysis of the Li content and the Nb content, (2) quantitative analysis of the water content, and (3) measurement of the surface energy (polar component and dispersive component) values. Tables 1 and 2 show the results.

A coated active material according to Comparative Example 1 was prepared by performing the same operation as in Example 1, except that, in “2. Preparation of Slurry” of Example 1 above, the coating solution according to Comparative Example 1 was used instead of the coating solution according to Example 1.

For the prepared coated active material according Comparative Example 1, the same operation as in Example 1 was performed to calculate the value of “D90 (μm) of coated active material/D90 (μm) of electrode active material”.

Also, the coated active material according to Comparative Example 1 was subjected to surface element analysis using X-ray photoelectron spectroscopy in the same manner as in Example 1, the element ratio of the surface was obtained from the various peaks of Nb_{3d}, Ni₂ₚ₃, Co₂ₚ₃, and Mn₂ₚ₃, and the coverage was calculated. The value of the coverage of the coated active material according to Comparative Example 1 was used as the reference value. Table 2 shows the results.

### Comparative Example 2

In “3. Preparation of Coated Active Material Precursor” of Comparative Example 1 above, the collected coated active material precursor according to Comparative Example 2 was supplied to an opening of the spray dryer from which the spray nozzle was removed, at a rate of about 0.5 g/sec using a dispensing spoon, and subjected to additional disintegration in a cyclone air flow. Then, a coated active material according to Comparative Example 2 was prepared by performing the same operation as in Comparative Example 1, except that the coated active material precursor subjected to the additional disintegration was used.

For the prepared coated active material according Comparative Example 2, the same operation as in Example 1 was performed to calculate the value of “D90 (μm) of coated active material/D90 (μm) of electrode active material” and also calculate the amount of change in the coverage using the value of the coverage of the coated active material according to Comparative Example 1 described above as the reference value, and the value of the amount of change in the coverage was obtained as a relative value of the increase/decrease in the coverage. Table 2 shows the results.

### Comparative Example 3

In “3. Preparation of Coated Active Material Precursor” of Comparative Example 1 above, the collected coated active material precursor according to Comparative Example 2 was supplied to an opening of the spray dryer from which the spray nozzle was removed, at a rate of about 0.5 g/sec using a dispensing spoon, and subjected to additional disintegration in a cyclone air flow. Subsequently, the coated active material precursor subjected to the additional disintegration was supplied to the opening of the spray dryer from which the spray nozzle was removed, at a rate of about 0.5 g/sec using a dispensing spoon, and subjected to additional disintegration for a second time in a cyclone air flow. Then, a coated active material according to Comparative Example 3 was prepared by performing the same operation as in Comparative Example 1, except that the coated active material precursor subjected to additional disintegration twice was used.

For the prepared coated active material according Comparative Example 3, the same operation as in Example 1 was performed to calculate the value of “D90 (μm) of coated active material/D90 (μm) of electrode active material” and also calculate the amount of change in the coverage using the value of the coverage of the coated active material according to Comparative Example 1 described above as the reference value, and the value of the amount of change in the coverage was obtained as a relative value of the increase/decrease in the coverage. Table 2 shows the results.

### Comparative Example 4

In “3. Preparation of Coated Active Material Precursor” of Comparative Example 1 above, the collected coated active material precursor according to Comparative Example 2 was supplied to an opening of the spray dryer from which the spray nozzle was removed, at a rate of about 0.5 g/sec using a dispensing spoon, and subjected to additional disintegration in a cyclone air flow. Subsequently, the coated active material precursor subjected to the additional disintegration was further supplied to the opening of the spray dryer from which the spray nozzle was removed, at a rate of about 0.5 g/sec using a dispensing spoon, and subjected to additional disintegration in a cyclone air flow. This process was performed twice, and thus, additional disintegration was performed a total of three times. Then, a coated active material according to Comparative Example 4 was prepared by performing the same operation as in Comparative Example 1, except that the coated active material precursor subjected to additional disintegration three times was used.

For the prepared coated active material according Comparative Example 4, the same operation as in Example 1 was performed to calculate the value of “D90 (μm) of coated active material/D90 (μm) of electrode active material” and also calculate the amount of change in the coverage using the value of the coverage of the coated active material according to Comparative Example 1 described above as the reference value, and the value of the amount of change in the coverage was obtained as a relative value of the increase/decrease in the coverage. Table 2 shows the results.

### Example 7

First, 0.7226 g of lithium phosphate was mixed with 170 mL of pure water, and aqueous ammonia was added to the mixture. The prepared mixed liquid of lithium phosphate and water was sufficiently stirred in the air while the temperature was adjusted so that the liquid temperature of the mixed liquid was within a range of 20° C. to 30° C., and thus, a transparent solution was obtained.

The obtained transparent solution was filtered through a membrane filter with a pore size of 0.5 μm, and thus, a solution containing Li and phosphoric acid was obtained.

Then, 0.3 g of EMULGEN 108 (manufactured by Kano Corporation) was added to 29.7 g of the obtained solution containing Li and phosphoric acid, and the resulting mixture was stirred for 10 minutes or longer while the temperature was adjusted so that the liquid temperature was within a range of 20° C. to 30° C. Thus, a coating solution according to Example 7 was obtained.

The obtained coating solution according to Example 7 was subjected to (1) quantitative analysis of the Li content and the P content, (2) quantitative analysis of the water content, and (3) measurement of the surface energy (polar component and dispersive component) values. Tables 1 and 2 show the results.

A coated active material according to Example 7 was prepared by performing the same operation as in Example 1, except that, in “2. Preparation of Slurry” of Example 1 above, the coating solution according to Example 7 was used instead of the coating solution according to Example 1.

For the prepared coated active material according Example 7, the same operation as in Example 1 was performed to calculate the value of “D90 (μm) of coated active material/D90 (μm) of electrode active material” and also calculate the amount of change in the coverage using the value of the coverage of the coated active material according to Comparative Example 5, which will be described later, as a reference value, and the value of the amount of change in the coverage was obtained as a relative value of the increase/decrease in the coverage. Table 2 shows the results.

Note that, in the X-ray photoelectron spectroscopy performed in Example 7, the peak of P₂ₚ was used instead of the peak of Nb_{3d}, and the coverage was calculated using the equation below:

Coverage (%)=(100×P)/(Ni+Co+Mn+P) (equation)

where the symbols of the elements represent the percentages [atomic %] of the respective elements.

### Comparative Example 5

A coating solution according to Comparative Example 5 was obtained by performing the same operation as in Example 7, except that the obtained solution containing Li and phosphoric acid was directly used without adding a surfactant to the solution containing Li and phosphoric acid.

The obtained coating solution according to Comparative Example 5 was subjected to (1) quantitative analysis of the Li content and the P content, (2) quantitative analysis of the water content, and (3) measurement of the surface energy (polar component and dispersive component) values, by performing the same operation as in Example 7. Tables 1 and 2 show the results.

A coated active material according to Comparative Example 5 was prepared by performing the same operation as in Example 1, except that, in “2. Preparation of Slurry” of Example 1 above, the coating solution according to Comparative Example 5 was used instead of the coating solution according to Example 1.

For the prepared coated active material according Comparative Example 5, the same operation as in Example 1 was performed to calculate the value of “D90 (μm) of coated active material/D90 (μm) of electrode active material”.

Also, the coated active material according to Comparative Example 5 was subjected to surface element analysis using X-ray photoelectron spectroscopy in the same manner as in Example 7, the element ratio of the surface was obtained from the various peaks of P₂ₚ, Ni₂ₚ₃, Co₂ₚ₃, and Mn₂ₚ₃, and the coverage was calculated. The value of the coverage of the coated active material according to Comparative Example 5 was used as the reference value. Table 2 shows the results.

### CONCLUSION

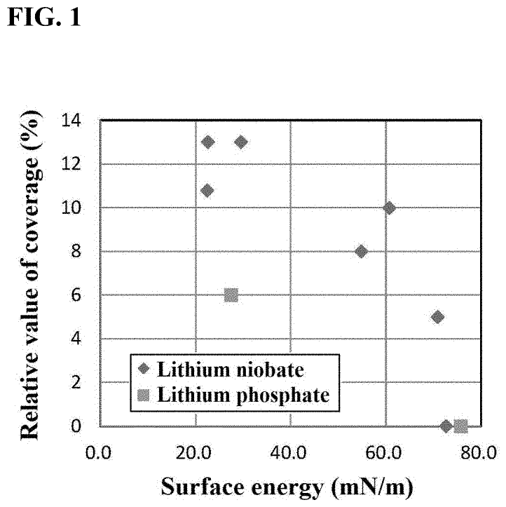

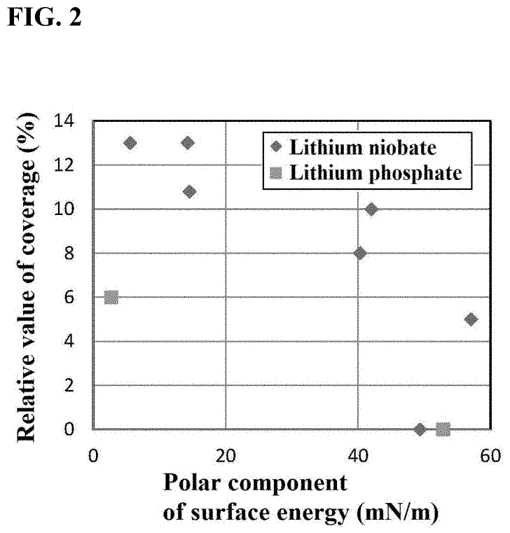

With respect to the above-described coating solutions according to Examples 1 to 7 and Comparative Examples 1 and 5, a graph showing the relationship between the value of the surface energy and the coverage is shown in FIG. 1, and a graph showing the relationship between the value of the polar component and the coverage is shown in FIG. 2.

From Table 2 and the graph in FIG. 1, it can be understood that, with respect to the coating solutions according to the examples, when the value of the surface energy is 72 mN/m or less, the coverage for the positive electrode active material is improved, and thus a high coverage is achieved.

From Table 2 and the graph in FIG. 2, it can also be understood that, with respect to the coating solutions according to the examples, when the value of the polar component of the surface energy is 45 mN/m or less, the coverage for the positive electrode active material is improved, and thus a high coverage is achieved.

From Table 2, it can be understood that, with respect to the coating solutions according to the examples, when the value of the surface energy is 72 mN/m or less, the value of “D90 (μm) of coated active material/D90 (μm) of electrode active material” is reduced and approaches 1.0, or in other words, the frequency of granule formation is suppressed, as a result of using the coating solution with low surface energy.

From the foregoing results, it was found that both high processing quality and a high processing speed can be achieved by drying a slurry using a coating solution with low surface energy in an air flow. A similar effect was also confirmed when lithium phosphate was chosen as the coating material instead of lithium niobate.

In contrast, with respect to Comparative Examples 1 to 4 in which the coating solutions having a surface energy value of more than 72 mN/m were used, the value of “D90 (μm) of coated active material/D90 (μm) of electrode active material” was greater than that of Examples 1 to 6, and it is considered that granules were formed. Similarly, the value of “D90 (μm) of coated active material/D90 (μm) of electrode active material” of Comparative Example 5 was greater than that of Example 7.

Here, it is conceivable to additionally disintegrate the granules, but as shown in Comparative Examples 2 to 4, additional disintegration has the problem in that it causes a decrease in the coverage and a decrease in the processing quality, and also requires an extra step, which results in a decrease in the processing speed.

TABLE 1

| | | Additive | | Li | Element M | | | |
|---|---|---|---|---|---|---|---|---|
| | | | Amount added | Content | | Content | Li/M | Water content |
| | Solution | | (mass %) | (mass %) | | (mass %) | (mole ratio) | (mass %) |
| Ex. 1 | Lithium niobate | 1,2-propanediol | 1.0 | 0.53 | Nb | 5.49 | 1.29 | 79 |
| Ex. 2 | Lithium niobate | 1,2-propanediol | 10.0 | 0.48 | Nb | 5.00 | 1.29 | 73 |
| Ex. 3 | Lithium niobate | Ftergent 222F | 0.1 | 0.53 | Nb | 5.54 | 1.28 | 80 |
| Ex. 4 | Lithium niobate | Ftergent 222F | 1.0 | 0.53 | Nb | 5.49 | 1.29 | 79 |
| Ex. 5 | Lithium niobate | LEOCOL TD-120 | 1.0 | 0.53 | Nb | 5.49 | 1.29 | 79 |
| Ex. 6 | Lithium niobate | DEDG | 1.0 | 0.53 | Nb | 5.49 | 1.29 | 79 |
| Com. Ex. 1 | Lithium niobate | None | — | 0.53 | Nb | 5.55 | 1.28 | 80 |
| Com. Ex. 2 | | | | | | | | |
| Com. Ex. 3 | | | | | | | | |
| Com. Ex. 4 | | | | | | | | |
| Ex. 7 | Lithium phosphate | EMULGEN 108 | 1.0 | 0.39 | P | 1.61 | 1.08 | 89 |
| Com. Ex. 5 | Lithium phosphate | None | — | 0.39 | P | 1.63 | 1.07 | 90 |

TABLE 2

| | | | | D90 of | |
|---|---|---|---|---|---|
| | | | | coated | |
| | | | | active | |
| | | | | material/ | |
| | | | | D90 of | |
| | | Surface energy | | electrode | Coverage |
| | | Dispersive | Polar | active | Relative |
| | | component | component | material | value |
| | (mN/m) | (mN/m) | (mN/m) | (μm/μm) | (%) |
| Ex. 1 | 70.9 | 13.8 | 57.1 | 1.27 | +5 |
| Ex. 2 | 60.7 | 18.7 | 42.0 | 1.15 | +10 |
| Ex. 3 | 22.4 | 7.9 | 14.5 | 1.26 | +11 |
| Ex. 4 | 22.6 | 8.3 | 14.3 | 1.18 | +13 |
| Ex. 5 | 29.5 | 23.9 | 5.6 | 1.32 | +13 |
| Ex. 6 | 54.8 | 14.5 | 40.3 | 1.43 | +8 |
| Com. Ex. 1 | 72.7 | 23.3 | 49.4 | 1.70 | Reference |
| | | | | | value |
| Com. Ex. 2 | | | | 1.61 | −9 |
| Com. Ex. 3 | | | | 1.58 | −7 |
| Com. Ex. 4 | | | | 1.57 | −7 |
| Ex. 7 | 27.5 | 24.8 | 2.7 | 1.16 | +6 |
| Com. Ex. 5 | 75.8 | 22.9 | 52.9 | 1.24 | Reference |
| | | | | | value |

What is claimed is:

1. A method for producing a coated active material, the method comprising:
mixing an electrode active material and a coating solution containing Li and an element M and having a surface energy of 72 mN/m or less to prepare a slurry; and
drying the slurry in an air flow and thereby causing a Li-containing oxide to adhere to at least a portion of a surface of the electrode active material, to obtain a coated active material,
where the element M is at least one element selected from Nb, F, Fe, P, Ta, V, Ge, B, Al, Ti, Si, W, Zr, Mo, S, Cl, Br, and I.

2. The method for producing a coated active material according to claim 1, wherein the coating solution contains Li in an amount of 0.1 mass % or more and 5.0 mass % or less, the element M in an amount of 0.05 mass % or more and 35 mass % or less, and water in an amount of 60 mass % or more and 98.4 mass % or less.

3. The method for producing a coated active material according to claim 1, wherein the element M is at least one element selected from Nb and P.

4. The method for producing a coated active material according to claim 2, wherein the element M is at least one element selected from Nb and P.

5. A coated active material, which is a dry product of a mixture of an electrode active material and a coating solution containing Li and an element M and having a surface energy of 72 mN/m or less,
where the element M is at least one element selected from Nb, F, Fe, P, Ta, V, Ge, B, Al, Ti, Si, W, Zr, Mo, S, Cl, Br, and I.

6. An all-solid-state battery comprising the coated active material according to claim 5 as a positive electrode active material.
